(19) United States
(12) Patent Application Publication
(10) Pub. No.: US 2014/0154447 A1
(43) Pub. Date: Jun. 5, 2014

(54) Peelable adapter element

(71) Applicant: AIRBUS OPERATIONS GMBH, Hamburg (DE)

(72) Inventor: Ralf Gevers, Bremen (DE)

(73) Assignee: AIRBUS OPERATIONS GMBH, Hamburg (DE)

(21) Appl. No.: 13/982,914

(22) PCT Filed: Jan. 13, 2012
(86) PCT No.: PCT/EP2012/050526

§ 371 Date: Feb. 17, 2014

Related U.S. Application Data
(60) Provisional application No. 61/483,663, filed on May 7, 2011.

(30) Foreign Application Priority Data
Feb. 2, 2011 (DE) 102011003524.9

(51) Int. Cl. B32B 7/06; B32B 15/08

(52) U.S. Cl. CPC B32B 7/06; B32B 15/08
USPC 428/41.1; 428/40.9

(57) ABSTRACT

A peelable adapter element for balancing out assembly and/or component tolerances, with a core body to define a minimum dimension and at least one stack of films bound to the core body to define a maximum dimension, which includes a plurality of peelable metal films detachably joined with each other by a respective binder film. The core body is formed of a plastic matrix with integrated fiber reinforcement.

### CROSS-REFERENCES TO RELATED APPLICATIONS

This application claims the benefit of the U.S. Provisional Application No. 61/438,663, filed on Feb. 2, 2011, and of the German patent application No. 10 2011 003 524.9 filed on Feb. 2, 2011, the entire disclosures of which are incorporated herein by way of reference.

### BACKGROUND OF THE INVENTION

The invention relates to a peelable adapter element for balancing out assembly and/or component tolerances.

Adapter elements for balancing out assembly and/or component tolerances are known as gap fillers, washers, spacers and the like, and are routinely used in assembly. Basically known are adapter elements with prescribed, invariable external dimensions and adapter elements with reducible external dimensions. The latter often consist of a stack of films with a plurality of individually detachable films, thereby permitting use given a plurality of assembly and/or component tolerances. The maximum external dimensions are determined by the number of films, wherein the corresponding number of films is removed to set individual, maximum external dimensions or a required overall height or overall thickness. European Patent EP 1 284 224 B1 depicts such an adapter element, hereinafter referred to as a peelable adapter element. The latter has a plurality of plastic films combined to form a stack of films, and exhibits a correspondingly low weight. However, the films must be soft enough or exhibit a high enough elasticity to be peeled, so that this adapter element is only conditionally pressure and temperature resistant. Due to their high elasticity, the plastic films are also subject to high mechanical wear, and exhibit a low chemical resistance.

European patent EP 0 667 233 B1 discloses an alternative peelable adapter element. The latter has a core body made of plastic, and at least one stack of films comprised of a plurality of metal films, which is detachably bound to the core body. While the metal films do improve resistance to mechanical wear and chemical resistance, this adapter element is also only conditionally pressure and temperature resistant.

Additionally known from European application EP 2 248 661 A1 is a peelable adapter element, in which the stack of films consists of a plurality of plastic films that exhibit differing physical properties, such as electrical conductivity.

### SUMMARY OF THE INVENTION

The object of the invention is to provide a peelable adapter element to balance out assembly and/or component tolerances, which eliminates the aforementioned disadvantages, and in particular exhibits a high compressive strength and an improved temperature resistance.

This object is achieved by means of an adapter element with variable external geometry or height.

A peelable adapter element according to the invention for balancing out assembly and/or component tolerances has a core body to define a minimum dimension, and at least one stack of films bound to the core body to define a maximum dimension, which exhibits a plurality of peelable metal films detachably joined together by a respective binder film. According to the invention, the core body is designed as a plastic matrix with integrated fiber reinforcement. Due to the fiber reinforcement, such an adapter element exhibits a compressive strength elevated by approx. twofold in comparison with the known adapter elements, using the same plastic. An improved temperature resistance can also be observed, for example, thereby enabling use at temperatures starting at approx. 80° C. without having to be concerned about any elastic or plastic deformation of the adapter element. In addition, the adapter element is weight-optimized and correspondingly light. The metal films also increase the chemical resistance and ability to withstand mechanical wear.

In a preferred exemplary embodiment, the fiber reinforcement consists of a single-ply or multi-ply matt, woven, and knitted fabric, individual freely distributed fibers and the like from a plurality of carbon fibers, glass fibers, textile fibers and/or natural fibers. The fiber orientation depends in particular on the load direction. The plastic used for manufacturing the matrix is especially a duroplastic or thermoplastic. For example, the matrix can consist of an epoxy resin.

For example, in order to be able to freely select the film material when using carbon fibers, the fibers in one exemplary embodiment are completely enveloped by the plastic. They are arranged in the matrix in such a way that the matrix exhibits a lateral region completely free of fibers. One exemplary embodiment that is easy to fabricate from a production standpoint uses conventionally manufactured, i.e., machined outer contours, in which the fibers at least occasionally also exit the matrix from the side.

The material or material alloy of metal films depends primarily on where the adapter element is being used. In mobile applications, in particular in aerospace, it is advantageous for the metal films to be made out of a light material, such as aluminum or titanium. In particular titanium also has the advantage that no corrosion arises during contact with carbon fibers, so that even if a carbon fiber exits on the side, corrosion to the metal film directly bound to the core material (core-proximate metal film) is precluded, and the adapter element cannot be weakened. Alternatively, the metal films can also be fabricated out of a stainless steel. This solution is especially suitable for use in stationary applications, and relatively cost-effective based on the selected material.

In one exemplary embodiment, the films exhibit a uniform height. As a result, the required maximum dimension can be set by simply counting off the films to be removed.

In another exemplary embodiment, a stack of films is situated on either side of the core body, so that, by comparison to the exemplary embodiment with only one stack of films, this exemplary embodiment makes it possible to balance out higher assembly and/or component tolerances, and is very flexible to use.

In one variant, the metal films of both stacks of films exhibit a uniform height, making it easy to set the required maximum dimension.

In another variant, the metal films in one stack of films have a different height than the metal films in the other stack of films. This solution provides for quasi-intermediate dimensions, making it possible to finely adjust the required maximum dimension, so that the assembly and/or component tolerances can be optimally evened out.

The stacks of film can basically exhibit a uniform number of metal films, or a different number of metal films.

In one exemplary embodiment, the metal films in the one stack of films consist of another material than the metal films in the other stack of films. In like manner, the materials within the stack of films can vary, so that individual metal films serve as a quasi insulator. For example, the core body is provided with fiber reinforcement consisting of carbon fibers in one embodiment, wherein at least the core-proximate metal film consists of titanium, and the core-remote metal films consist of a more cost-effective metal material, so as to prevent contact corrosion on the metal films in cases where carbon fibers exit from the side.

Other advantageous exemplary embodiments of the invention are the subject of additional subclaims.

It is also conceivable that the films be made out of a plastic with respectively integrated fiber reinforcement, making it possible to further reduce the overall weight of the adapter element while retaining a high compressive strength and improved temperature resistance. Metal films can also be combined with fiber-reinforced plastic films, wherein in particular the plastic films serve as a quasi insulator. For example, the core body can exhibit fiber reinforcement comprised of carbon fibers, wherein at least the core-proximate plastic film is reinforced with glass fibers to prevent contact corrosion of the metal films given carbon fibers exiting from the side.

### BRIEF DESCRIPTION OF THE DRAWINGS

Preferred exemplary embodiments of the invention will be explained in greater detail below based on diagrammatic views. Shown on:

FIG. 1 is a perspective view of a first exemplary embodiment of a peelable adapter element according to the invention, and

FIG. 2 is a perspective view of a second exemplary embodiment of an adapter element according to the invention.

Identical structural elements on the figures bear the same reference numbers, wherein only a few of the elements are provided with a reference number in the respective figure for reasons of clarity.

### DETAILED DESCRIPTION OF THE PREFERRED EMBODIMENTS

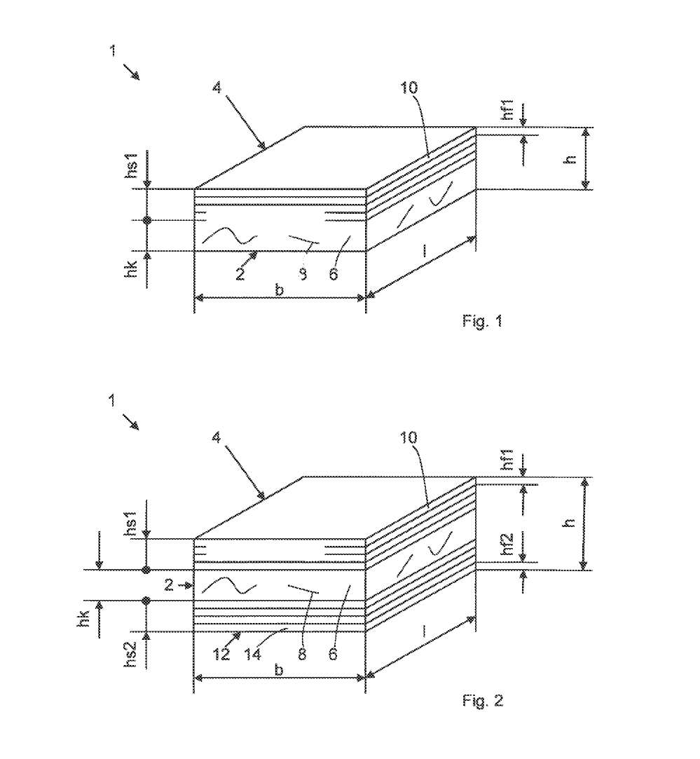

FIG. 1 shows a first exemplary embodiment of an adapter element 1 according to the invention for balancing out assembly and/or component tolerances with a variable external geometry. It has a rectangular outer contour, with a width b, a length l and a reducible overall height h. It consists of a core body 2 and stack of films 4, which are peelably joined together and define the overall height h. Of course, other geometric bodies are also conceivable, e.g., cylinders with a full cross section or hollow cross section.

The core body 2 exhibits a matrix 6 consisting of a plastic with integrated fiber reinforcement 8, and has a height hk that defines a minimum dimension. Examples for matrix materials include thermoplastics or duroplastics, such as epoxy resins. The fiber reinforcement 8 depicted in a graphically highly simplified form is used in particular to achieve a high compressive strength, and preferably a woven fabric consisting of a plurality of fibers, e.g., carbon or glass fibers. As a consequence, the core body 2 is a carbon or glass fiber-reinforced plastic composite (CFK or GFK).

The core body 2 is preferably manufactured by providing a dry fiber material as the fiber reinforcement 8, followed by embedding into the matrix material and concluding with consolidation or compaction and curing (duroplastic matrix) or setting (thermoplastic matrix).

The stack of films 4 has a height hs1 and consists of a plurality of metal films 10, which are adhesively bonded to each other via a binding agent with a low peeling strength, and can be individually removed to set a required maximum dimension. Due to their material, the metal films 10 in particular exhibit a high chemical resistance, and a low mechanical wear. Preferred materials for the metal films 10 are titanium or stainless steel or corresponding light metal alloys, such as aluminum. However, more cost-effective metals are also used, depending on the type of application.

FIG. 2 shows a second exemplary embodiment of a peelable adapter element 1 according to the invention for balancing out assembly and/or component tolerances with a width b, a length l and a reducible overall height h. As opposed to the first exemplary embodiment according to FIG. 1 described above, the latter has a stack of films 4, 12 with an identical number of peelable metal films 10, 14 on either side of a core body 2 having a fiber-reinforced plastic matrix 6. The material or stock comprising the core body 2 and metal films 10, 14 in this exemplary embodiment are each identical with the materials of the first exemplary embodiment according to FIG. 1.

The overall height h or maximum dimension of the adapter element 1 is defined via the sum of individual heights hs1 and hs2 of the stack of films 4 and 12 with the height hk of the core body 2. The respective height hs1, hs2 of the stack of films 4, 12 is here respectively determined by the number of metal films 10, 14 that have not been peeled off. The latter each exhibit a constant height hf1, hf2 at least inside of the stack, wherein hf1=hf2 holds true. However, the films 10, 14 can alternatively also exhibit varying heights hf1, hf2 to achieve a finer gradation, so that hf1≠hf2 applies.

A peelable adapter element for balancing out assembly and/or component tolerances is disclosed, with a core body to define a minimum dimension and at least one stack of films bound to the core body to define a maximum dimension, which exhibits a plurality of peelable metal films detachably joined with each other by a respective binder film, wherein the core body is designed as a plastic matrix with integrated fiber reinforcement.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

### Reference List

1 Adapter element
2 Core body
4 Stack of films
6 Matrix
8 Fiber reinforcement
10 Metal film
12 Stack of films
14 Metal film
b Width
l Length
h Overall height (maximum dimension)
hk Height, core body (minimum dimension)
hs1 Height, first stack of films
hf1 Height, film of first stack of films
hs2 Height, second stack of films
hf2 Height, film of second stack of films

1-11. (canceled)

12. A peelable adapter element for balancing out at least one of assembly and component tolerances, having a core body defining a minimum dimension and at least one stack of films bound to the core body defining a maximum dimension, the stack of films comprising a plurality of peelable metal films joined together by a respective binder film, wherein the core body is a plastic matrix with integrated fiber reinforcement.

13. The adapter element according to claim 12, wherein the fiber reinforcement comprises at least one of carbon fibers, glass fibers, textile fibers and natural fibers.

14. The adapter element according to claim 12, wherein the fiber reinforcement is completely incorporated into the matrix.

15. The adapter element according to claim 12, wherein the metal films are formed of a light metal material.

16. The adapter element according to claim 15, wherein the metal films are formed of one of aluminum and titanium.

17. The adapter element according to claim 12, wherein the metal films are fabricated out of a stainless steel.

18. The adapter element according to claim 12, wherein the metal films have a uniform height.

19. The adapter element according to claim 12, wherein a stack of films is arranged on both sides of the core body.

20. The adapter element according to claim 19, wherein the metal films in both stacks of films have a uniform height.

21. The adapter element according to claim 19, wherein the metal films have varying heights.

22. The adapter element according to claim 19, wherein the stacks of films comprise a uniform number of metal films.

23. The adapter element according to claim 12, wherein the metal films comprise varying materials.
